(19) United States
(12) Patent Application Publication
(10) Pub. No.: US 2013/0205191 A1
(43) Pub. Date: Aug. 8, 2013

(54) SYSTEMS AND METHODS OF ELECTRONIC VISITOR REGISTRATION

(71) Applicants: Gayathri C. Ramachandran, Coimbatore (IN); Sivakumar Balakrishnan, Madurai (IN); Muthuvel Ramalingamoorthy, Madurai (IN)

(72) Inventors: Gayathri C. Ramachandran, Coimbatore (IN); Sivakumar Balakrishnan, Madurai (IN); Muthuvel Ramalingamoorthy, Madurai (IN)

(73) Assignee: Honeywell International Inc., Morristown, NJ (US)

(21) Appl. No.: 13/368,843

(22) Filed: Feb. 8, 2012

(51) Int. Cl. G06F 17/20

(52) U.S. Cl. 715/226

(57) ABSTRACT

Systems and methods of electronic visitor registration are provided. Methods include receiving visitor information via a wireless communication medium, extracting at least one piece of data from the received visitor information, populating respective fields of a registration form with the extracted at least one piece of data, and based on the populated registration form, determining whether to register a visitor associated with the received visitor information.

### FIELD OF INVENTION

The present invention relates generally to visitor management systems. More particularly, the present invention relates to wireless systems and methods for electronic visitor registration.

### BACKGROUND

In many large buildings and facilities, for example, corporate or manufacturing facilities, security is important. Thus, many large buildings employ visitor management systems to handle a guest's check in and check out process, for example, registering a guest of the building.

In known visitor management systems, when a guest or visitor arrives at a building, he must check in with security to register. Because physical presence and verification is required, a guest must present identification. Known systems and methods of visitor registration manually scan a guest's identification card, for example, a driver's license and/or business card. This can be a time consuming and tedious process, causing guests of a building to wait in long lines before completing the registration process. For example, there may be a line to register when several guests arrive at a building simultaneously.

Furthermore, known systems and methods of visitor registration must depend on a third party tool for scanning a guest's identification card. Third party scanning tools can require a customized format to recognize information on identification cards. However, the format of identification cards can vary in different regions, thus lengthening the registration process even more and causing less than 100% accuracy in retrieving information from the identification cards.

When the registration process is complete, security of a building often issues a physical temporary access badge to the guest for use in traversing the building. However, when the guest has completed his visit, the guest must check out with security so as to surrender the physical temporary access badge.

There is thus a continuing, ongoing need for improved systems and methods for electronic visitor registration.

### BRIEF DESCRIPTION OF THE DRAWINGS

FIG. 1 is a flow diagram of a method of electronic visitor registration in accordance with embodiments disclosed herein;

FIG. 2 is a block diagram of a system for carrying out the method of FIG. 1 and others disclosed herein; and

FIG. 3 is a block diagram of the central registration station shown in FIG. 2.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include improved systems and methods for electronic visitor registration. For example, visitor registration can include transferring visitor information from a guest's mobile device to systems disclosed herein. In some embodiments, the visitor information can be transmitted using, for example, near field communication (NFC) and/or Bluetooth technology.

In embodiments that employ Bluetooth technology, systems disclosed herein can employ a Bluetooth port that is open for receiving Bluetooth transmissions. For example, systems and methods disclosed herein can monitor the Bluetooth port for incoming visitor information and/or a vCard.

It is to be understood that a visitor's mobile device does not limit the embodiments disclosed herein. Rather, a visitor's mobile device can be any mobile device as in known in the art, including, but not limited to, a cellular phone, a smart phone, a personal digital assistant, and any other handheld device as would be known by those of skill in the art.

It is also to be understood that the technology employed for the wireless transmissions described herein does not limit the embodiments disclosed herein. Rather, the technology employed for wirelessly transmitting visitor information and/or visitor badges between a visitor's mobile device and systems disclosed herein can use wireless communication technology, including, but not limited to, short messaging service (SMS), NFC, Bluetooth, web-based systems, GSM, and the like.

According to some embodiments, when a new visitor arrives at a building, for example, when the visitor's mobile device detects a signal indicating the ambient environment (i.e. the front desk), the visitor's mobile device can transmit the visitor's information to systems disclosed herein and employed by the building. In some embodiments, the visitor's mobile device can automatically transmit the visitor's information while the visitor is entering the building or substantially immediately after the visitor enters the building, for example, when the visitor is in the lobby or in the front office of the building. In other embodiments, the visitor can provide user input to his mobile device to transmit his registration information.

In some embodiments, the visitor's registration information transmitted from the visitor's mobile device can include information including, but not limited to, the visitor's name, address, phone number, email address, URL, logo, photograph, audio clip, demographic information, and the like. In some embodiments, the visitor's information can also include and/or be contained in a vCard, which is a file format standard for electronic business cards. However, it is to be understood that the visitor's information is not so limited and can include any information and be in any format as comes within the spirit and scope of the embodiments disclosed herein.

In some embodiments, visitor information can be stored in an XML format. In these embodiments, systems and methods disclosed herein can parse the visitor information to retrieve each piece of information.

According to some disclosed embodiments, a single visitor's mobile device can facilitate the registration of a group of visitors. For example, the single visitor's mobile device can transmit a plurality of visitors' information, including a plurality of visitors' vCards, to systems disclosed herein and employed by a building. The single visitor's mobile device can obtain the information and/or vCards for the plurality of visitors from, for example, the contact list in the single visitor's mobile device.

When systems and methods according to embodiments disclosed herein receive visitor information, systems and methods can use the received visitor information to pre-populate a registration form. For example, when the received visitor information is in and/or includes a vCard, systems and methods disclosed herein can extract the visitor information from the vCard and pre-populate respective fields of a registration form with the extracted information, for example, the visitor's demographic information and photograph.

If all of the required fields of the registration form are completed with the pre-populated information, the visitor can be registered. For example, a user or operator can review the pre-populated visitor information and provide a single input to authorize the registration form and register the visitor.

If all of the required fields of the registration form are not completed with the pre-populated information, then additional information can be provided to complete the registration process. For example, a user or operator can review the pre-populated visitor information, and manually solicit additional information from the visitor to complete the remaining required fields in the registration form. Once the additional information is entered into the registration form, the operator can provide a single input to authorize the registration form and register the visitor.

In some embodiments, systems and methods can create a file or page for each visitor's pre-prepopulated registration form. After transmitting visitor information as described above, a visitor can approach a central registration station, for example, a front desk, and, a user or operator at the central registration station can view the respective file or page for the present visitor's pre-populated registration page. If requested, the visitor can present his physical identification card, and the user or operator view the pre-populated registration page and/or physical identification card before authorizing and registering the visitor.

When the visitor is registered, systems and methods can transmit an image to the visitor's mobile device, for example, as an acknowledgement that the registration process is complete. In some embodiments the image transmitted to the visitor's mobile device can be encrypted, and in some embodiments, the image transmitted to the visitor's mobile device can include a visitor badge, for example, an eBadge.

In some embodiments, the visitor badge transmitted the visitor's mobile device can be used by the visitor to traverse the building. For example, the visitor badge transmitted the visitor's mobile device can include those described and disclosed in U.S. application Ser. No. 13/151,580 titled “Establishing an E-Badge Via Mobile Pre-Registration for a Visitor Management System.” U.S. application Ser. No. 13/151,580 is assigned to the assignee hereof and is hereby incorporated by reference.

For example, the visitor badge can include a temporary access badge displayed directly on the visitor's mobile device. In some embodiments, the badge displayed on the visitor's mobile device can include a photograph of the visitor and/or a machine-readable representation of data, for example a barcode, that represents information about the visitor. Accordingly, the visitor can use the badge and/or key on his mobile device to check in with security and/or to open doors associated with access points throughout the building.

In some embodiments, the image transmitted to the visitor's mobile device can also include a route map for the building. For example, the route map transmitted the visitor's mobile device can be based on the visitor's current location.

In accordance with disclosed embodiments, systems and methods described herein can register multiple visitors of a building substantially simultaneously, thus, speeding up the registration process for visitors and eliminating long lines for registration. That is, the registration of multiple visitors of a building substantially simultaneously can enable quicker registration and reduce the wait time for visitors. For example, in some embodiments, systems and methods disclosed herein can receive a plurality of visitor information, review a plurality of pre-populated registration forms, and transmit a plurality of visitor badges to a plurality of different visitor mobile devices substantially simultaneously.

Some visitors to a building may not own a mobile device with appropriate visitor information for transmitting to systems disclosed herein. When these visitors visit the building for the first time, systems and methods disclosed herein can transmit a blank information form, for example, a blank vCard, to the visitor's mobile device. The visitor can complete received blank information form so that, in future visits to the building, the visitor's mobile device can transmit the visitor's information, for example, in the completed vCard, to systems disclosed herein and employed by the building.

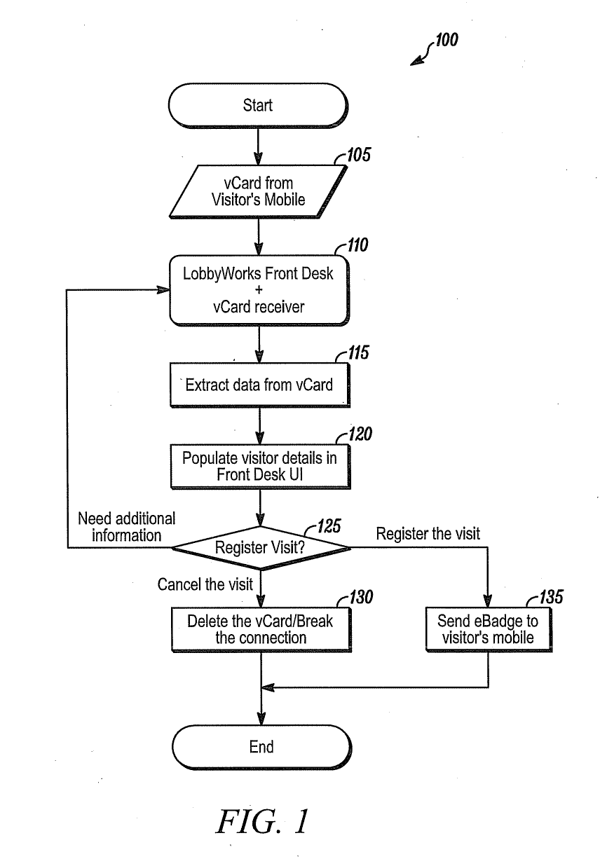

FIG. 1 is a flow diagram of a method 100 of electronic visitor registration in accordance with embodiments disclosed herein. As seen in FIG. 1, the method 100 can include transmitting a vCard from a visitor's mobile device as in 105. The visitor's vCard can be received by systems disclosed herein, including, for example, a central registration station as in 110. In some embodiments, the central registration station can include a personal computer, and in some embodiments, the central registration station can be located at the front desk of a building.

After the visitor's vCard is received by the central registration station as in 110, the visitor's information in the vCard can be extracted as in 115. Then, respective fields in a registration form can be pre-populated with the extracted visitor information as in 120.

In some embodiments, the method 100 can determine whether to register the visitor as in 125. However, in other embodiments, the method 100 can receive a user input to determine whether to register the visitor as in 125. For example, the registration form, including the empty and/or pre-populated fields, can be displayed on a user interface of the central registration station, and a user or operator can review the registration form and determine whether to register the visitor as in 125.

If the method 100 determines that additional information is needed to register the visitor as in 125, then the method 100 can solicit more information from the visitor. For example, the method 100 can receive additional information from the visitor as in 110. In some embodiments, systems and methods disclosed herein can determine the additional information needed based on the pre-populated registration form. In other embodiments, systems and methods disclosed herein can receive a user input to identify the additional information needed.

If the method 100 determines that the registration process should be terminated as in 125, then the method 100 can delete the visitor's information, including the visitor's vCard, and/or break the connection with the visitor's mobile device as in 130. In some embodiments, systems and methods disclosed herein can determine when to cancel the registration process based on the pre-populated registration form. In other embodiments, systems and methods disclosed herein can receive a user input to determine when to cancel the registration process.

Finally, if the method 100 determines that the visitor should be registered as in 125, then the method 100 can register the visitor and send an image, for example, a visitor badge, to the visitor's mobile device as in 135. In some embodiments, systems and methods disclosed herein can determine when to send a visitor badge to a visitor's mobile device based on the pre-populated registration form. In other embodiments, systems and methods disclosed herein can receive a user input to determine when to send a visitor badge to a visitor's mobile device.

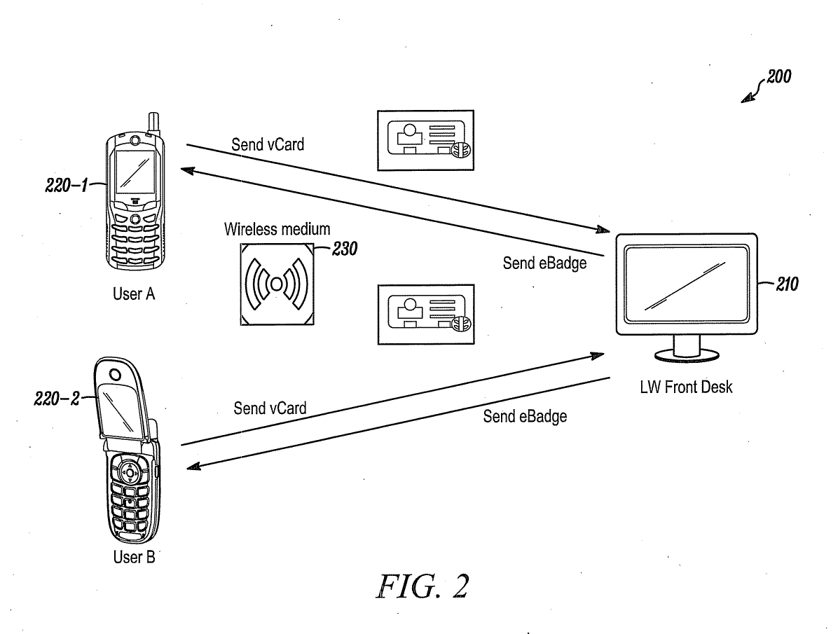

The method shown in FIG. 1 and others disclosed herein can be implemented with a system 200. As seen in FIG. 2, the system 200 can include a central registration station 210 that can communicate with a plurality of mobile devices, for example, User A 220-1 and User B 220-2. As seen in FIG. 2, the central registration station 210 can communicate with User A 220-1 and User B 220-2 via a wireless medium 230, for example, Bluetooth or NFC.

Each of User A 220-1 and User B 220-2 can transmit visitor information stored therein, for example, a vCard, to the central registration station 210. Based on the received visitor information, the central registration station 210 can then transmit respective visitor badges to each of User A 220-1 and User B 220-2.

As seen in FIG. 2, the respective transmissions to and from User A 220-1 and the central station 210 and to and from User B 220-2 and the central station 210 can occur substantially simultaneously. That is, the central station 210 can communicate with and register User A 220-1 while substantially simultaneously communicating with and registering User B 220-2. Communication between User A 220-1 and the central station 210 does not interfere with communication between User B 220-2 and the central station 210.

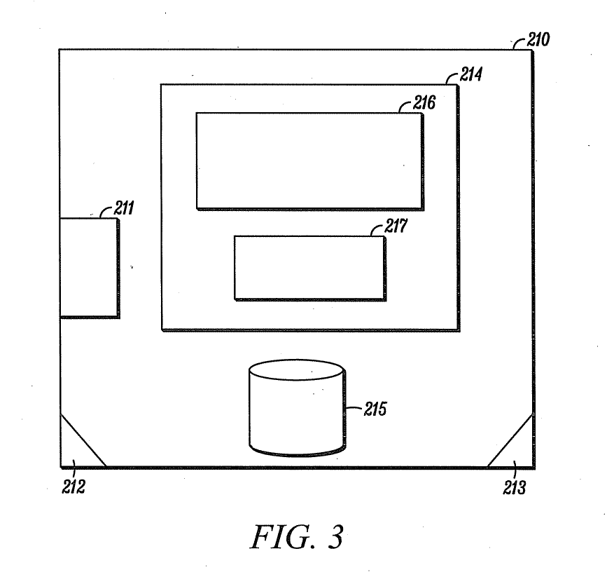

FIG. 3 is a block diagram of the central registration station 210 shown in FIG. 2. As seen in FIG. 3, the central station 210 can include a transceiver 211, one or more programmable processors 212, and executable control software 213 as would be understood by those of ordinary skill in the art. In some embodiments, the central registration station 210 can also include a user interface device 214 and a memory device 215, for example, a database or server.

The user interface device 214 can include a viewing screen 216, as would be known by those of skill in the art, and one or more user input mechanisms 217. In some embodiments, the viewing screen 216 can display interactive and viewing windows, and in some embodiments, the user interface device 214 can be a multi-dimensional graphical user interface. In some embodiments, the user input mechanisms 217 can include, for example, a keypad or a mouse, that can receive user input.

The executable control software 213 can implement the method shown and described in FIG. 1 as well as others described herein. Further, the executable control software 213 can be stored on a transitory or non-transitory local computer readable medium, including, but not limited to, local computer memory, RAM, optical storage media, magnetic storage media, flash memory, etc.

In some embodiments, the transceiver 211 can include a Bluetooth port. However, the transceiver 211 is not so limited. Rather, the transceiver 211 can include any type of transceiver as would be known by one of ordinary skill in the art that can facilitate communication between the central registration station 210 and a visitor mobile device.

In accordance with embodiments disclosed herein, the central station 210 can electronically register a visitor to a building. For example, the central station 210 can receive visitor information, including a vCard, from a visitor's mobile device, pre-populate a registration form, determine whether to register the visitor based on the pre-populated registration form, and, after registering the visitor, transmit a visitor badge to the visitor's mobile device. In some embodiments, the viewing screen 216 can display the pre-populated registration form, and in some embodiments, the user input mechanisms 217 can receive user input to complete the registration process.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

From the foregoing, it will be observed that numerous variations and modifications may be effected without departing from the spirit and scope of the invention. It is to be understood that no limitation with respect to the specific system or method illustrated herein is intended or should be inferred. It is, of course, intended to cover by the appended claims all such modifications as fall within the spirit and scope of the claims.

1. A method comprising:
transmitting a blank visitor information form to a visitor's mobile device;
receiving a completed visitor information form from the visitor's mobile device via a wireless communication medium;
extracting at least one piece of data from the received completed visitor information form;
populating respective fields of a registration form with the extracted at least one piece of data; and
based on the populated registration form, determining whether to register a visitor associated with the received completed visitor information form.

2. The method of claim 1 wherein receiving the completed visitor information form includes receiving the completed visitor information form via at least one of Bluetooth, NFC, SMS, GSM, and a web-based system.

3. The method of claim 1 wherein receiving the completed visitor information form includes receiving a vCard containing visitor information.

4. The method of claim 3 wherein extracting the at least one piece of data from the received completed visitor information form includes extracting the last least one piece of data from the received vCard.

5. The method of claim 1 wherein visitor information in the received completed visitor information form includes at least one of name, address, phone number, email address, URL, logo, photograph, audio clip, and demographic information.

6. The method of claim 1 wherein receiving the completed visitor information form includes receiving a plurality of vCards containing visitor information for a plurality of visitors.

7. The method of claim 1 wherein determining whether to register the visitor associated with the received completed visitor information form includes determining whether all required fields in the registration form are populated.

8. The method of claim 1 wherein determining whether to register the visitor associated with the received completed visitor information form includes soliciting additional information to complete unpopulated fields in the registration form.

9. The method of claim 1 further comprising deleting the received completed visitor information form.

10. The method of claim 1 further comprising transmitting a registration image associated with the received completed visitor information form.

11. The method of claim 10 wherein transmitting the registration image includes transmitting an electronic visitor badge.

12. The method of claim 1 further comprising:
substantially simultaneously receiving, via the wireless communication medium, a completed visitor information form for a plurality of visitors;
substantially simultaneously extracting at least one piece of data from the received completed visitor information form for each of the plurality of visitors;
substantially simultaneously populating respective fields of a plurality of registration forms with the extracted pieces of data; and
based on the populated registration form, substantially simultaneously determining whether to register each of the plurality of visitors associated with the received completed visitor information forms.

13. A method comprising:
receiving a blank visitor information form; completing the blank visitor information form;
transmitting a completed visitor information form to a central registration station via a wireless communication medium; and
based on the transmitted completed visitor information form, receiving a registration image from the central registration station.

14. The method of claim 13 wherein transmitting the completed visitor information form includes transmitting the completed visitor information form via at least one of Bluetooth, NFC, SMS, GSM, and a web-based system.

15. The method of claim 13 wherein transmitting the completed visitor information form includes detecting a signal indicative of the central registration station and, responsive thereto, automatically transmitting the completed visitor information form.

16. The method of claim 13 wherein transmitting the completed visitor information form includes receiving a user input to transmit the completed visitor information form.

17. The method of claim 13 wherein transmitting the completed visitor information form includes transmitting visitor information for a plurality of visitors.

18. The method of claim 13 wherein receiving the registration image includes receiving an electronic visitor badge from the central registration station.

19. A system comprising:
a transceiver;
a programmable processor; and
executable software stored on a non-transitory computer readable medium for:
transmitting a blank visitor information form to a visitor's mobile device via the transceiver;
receiving a completed visitor information form from the visitor's mobile device via the transceiver;
extracting at least one piece of data from the received completed visitor information form;
populating respective fields of a registration form with the extracted at least one piece of data; and
based on the populated registration form, determining whether to register a visitor associated with the received completed visitor information form.

20. The system of claim 19 wherein the transceiver receives the completed visitor information form via a wireless communication medium including least one of Bluetooth, NFC, SMS, GSM, and a web-based system.
